(19) United States
(12) Patent Application Publication
(10) Pub. No.: US 2023/0394392 A1
(43) Pub. Date: Dec. 7, 2023

(54) PERSONNEL MANAGEMENT SYSTEM, METHOD, AND PROGRAM

(71) Applicant: Hitachi, Ltd., Tokyo (JP)

(72) Inventors: Satish Kumar JAISWAL, Tokyo (JP); Mineyoshi Masuda, Tokyo (JP); Jun Mizuno, Tokyo (JP)

(73) Assignee: Hitachi, Ltd., Tokyo (JP)

(21) Appl. No.: 18/173,710

(22) Filed: Feb. 23, 2023

(30) Foreign Application Priority Data
Jun. 2, 2022 (JP) 2022-090253

(51) Int. Cl. G06Q 10/0631

(52) U.S. Cl. CPC G06Q 10/063112

(57) ABSTRACT

A personnel management system includes: a storage device that stores management information and a software program; and a processor that refers to the management information and executes the software program. The management information includes job information, for each job, indicating a date and time when the job is to be executed and a skill required for the job, job performance information, for each job, recording a date and time when the job is actually executed and an execution result of the job, skill information indicating the number of necessary personnel having the skill for each skill, and personnel information indicating a skill possessed by the personnel for each skill. The processor specifies a skill in which personnel is insufficient, creates an OJT plan for the insufficient skill, and compares the execution result of the number of personnel having the insufficient skill before and after the OJT is executed.

### BACKGROUND OF THE INVENTION

### 1. Field of the Invention

The present disclosure relates to a technique for managing personnel who execute jobs.

### 2. Description of the Related Art

JP 2004-302571 A discloses a system that assigns personnel to an event requiring a job and trains personnel having a skill necessary for the job. When an event requiring a job occurs in the information system, the device assigning a person in charge in JP 2004-302571 A assigns personnel with high skills necessary for responding to the event and personnel with improved skills as personnel corresponding to the event. It is possible to improve the skills of educators while responding to the event by setting personnel with high necessary skills as educators and personnel who should improve the necessary skills as trainees.

### SUMMARY OF THE INVENTION

The technique of JP 2004-302571 A is considered to be useful for improving individual skills of each personnel member, but it is not clear whether the number of personnel members having skills necessary for each job is sufficient or insufficient as a whole organization. Various skills are required for various jobs, but it is not possible to know which skill is appropriate to be a target of education. Therefore, it is not easy to maintain a sufficient number of personnel having appropriate skills.

One object of the present disclosure is to provide a technology that enables management so as to secure personnel having skills necessary for jobs.

A personnel management system according to one aspect included in the present disclosure is a personnel management system that manages personnel who execute a job requiring a skill and includes: a storage device that stores management information and a software program; and a processor that refers to the management information and executes the software program. The management information includes job information, for each job, indicating a date and time when the job is to be executed and a skill required for the job, job performance information, for each job, recording a date and time when the job is actually executed and an execution result of the job, skill information indicating the number of necessary personnel having the skill for each skill, and personnel information indicating a skill possessed by the personnel for each skill. Based on the management information, the processor specifies an insufficient skill that is a skill in which personnel are insufficient based on the management information, creates an OJT plan defining a trainee, a trainer, and a job, and determining an OJT that causes the trainee to acquire the insufficient skill by executing the job with the trainer and the trainee, and compares execution results of the job related to the insufficient skill and/or the number of personnel having the insufficient skill before and after the OJT is executed.

According to one aspect of the present disclosure, it is possible to perform management so as to secure personnel having skills necessary for jobs.

### BRIEF DESCRIPTION OF THE DRAWINGS

FIG. 1 is a block diagram illustrating an overall system according to the present embodiment;

FIG. 2 is a block diagram of an OJT job assignment server;

FIG. 3 is a diagram illustrating a job table;

FIG. 4 is a diagram illustrating a skill table;

FIG. 5 is a diagram illustrating a personnel table;

FIG. 6 is a diagram illustrating a shift table;

FIG. 7 is a diagram illustrating an assignment table;

FIG. 8 is a diagram illustrating a job performance table;

FIG. 9 is a diagram illustrating an insufficient skill table;

FIG. 10 is a diagram illustrating a skill selection GUI;

FIG. 11 is a diagram illustrating an OJT plan creation GUI;

FIG. 12 is a diagram illustrating an OJT plan table;

FIG. 13 is a diagram illustrating an OJT assignment table;

FIG. 14 is a diagram illustrating an OJT plan confirmation GUI;

FIG. 15 is a diagram illustrating an OJT evaluation table;

FIG. 16 is a diagram illustrating an OJT evaluation GUI;

FIG. 17 is a flowchart of processing by a job assignment program;

FIG. 18 is a flowchart of processing by an OJT planning program;

FIG. 19 is a flowchart of processing of an insufficient skill determination module;

FIG. 20 is a flowchart of processing of an OJT job assignment module;

FIG. 21 is a flowchart of processing of a trainee selection module;

FIG. 22 is a flowchart of processing of an OJT job assignment module 2; and

FIG. 23 is a flowchart of processing of an OJT evaluation module.

### DESCRIPTION OF THE PREFERRED EMBODIMENTS

Hereinafter, embodiments of the invention will be described with reference to the accompanying drawings. In the present embodiment, an overall system for managing operations and employees in a company is illustrated. Business of a company includes various jobs.

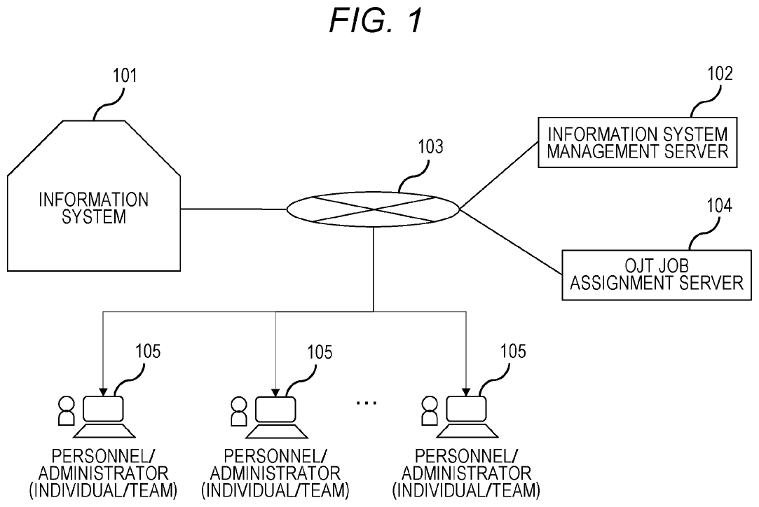

FIG. 1 is a block diagram illustrating an overall system according to the present embodiment. Referring to FIG. 1, an information system 101, an information system management server 102, an OJT job assignment server 104, and a terminal device 105 are interconnected via a network 103. The network 103 is a wired or wireless communication network such as the Internet, an intranet, or a local area network (LAN).

The information system 101 is a computer system for executing business. Business of a company has various jobs. A company has a large number of employees including personnel who execute each job in a shared manner. Each personnel shall be responsible for his/her skills and jobs according to their level.

The information system management server 102 is a server device for managing the information system 101. The information system management server 102 stores hardware and software configuration information of the information system 101. The administrator of the information system 101 operates and maintains the information system 101 using the information system management server 102. The information system management server 102 accumulates logs of operation and maintenance of the information system 101.

The OJT job assignment server 104 is a computer system that identifies a skill in which personnel are insufficient (hereinafter, also referred to as “insufficient skill”) in order to secure a necessary number of personnel with necessary skills, plans on the job training (OJT) for training personnel with insufficient skills, and evaluates the results of the implemented OJT. Details of the configuration and operation of the OJT job assignment server 104 will be described later.

The terminal device 105 is a computer used by an employee for work. The personnel assigned with the job executes the job using the terminal device 105. The administrator of the information system 101 operates and maintains the information system 101 from the terminal device 105 using the information system management server 102. The administrator who manages the job and the personnel uses an OJT job assignment server 104 from the terminal device 105 to assign the personnel to the job and plan and evaluate the OJT for training the personnel with insufficient skills.

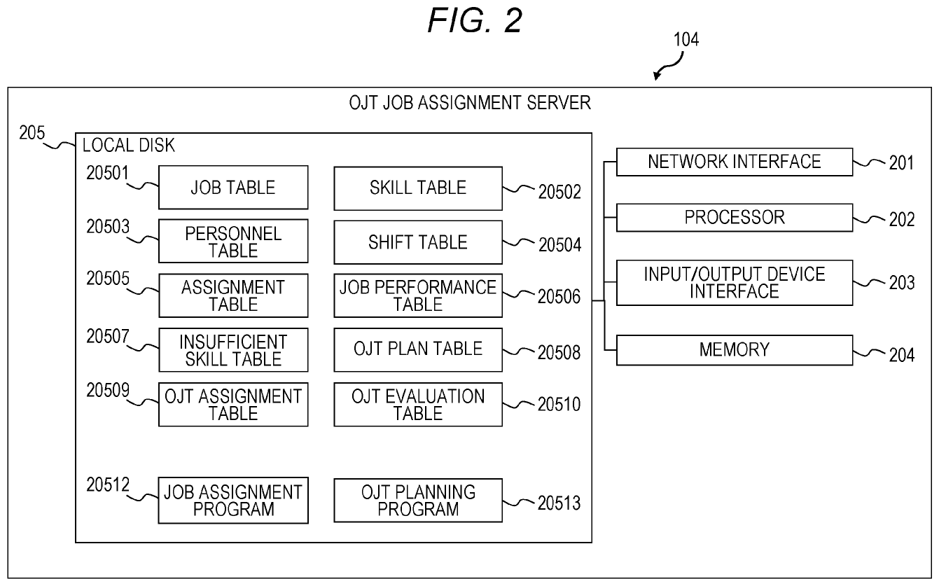

FIG. 2 is a block diagram of an OJT job assignment server. The OJT job assignment server 104 includes a computer including a network interface 201, a processor 202, an input/output device interface 203, a memory 204, and a local disk 205. The local disk 205 stores, as management information, a job table 20501, a skill table 20502, a personnel table 20503, a shift table 20504, an assignment table 20505, a job performance table 20506, an insufficient skill table 20507, an OJT plan table 20508, an OJT assignment table 20509, and an OJT evaluation table 20510. The local disk 205 stores a job assignment program 20512 and an OJT planning program 20513 as software programs.

The network interface 201 is an interface device for the OJT job assignment server 104 to transmit and receive data to and from other computers via the network 103. The processor 202 is a processing device that executes a software program using the memory 204. The input/output device interface 203 is an interface device that is connected to an input/output device such as a keyboard, a mouse, and a display and enables input/output of data.

The processor 202 executes the software program using the management information on the local disk 205 to implement various processes of the OJT job assignment server 104. Details of various processes of the OJT job assignment server 104 will be described later.

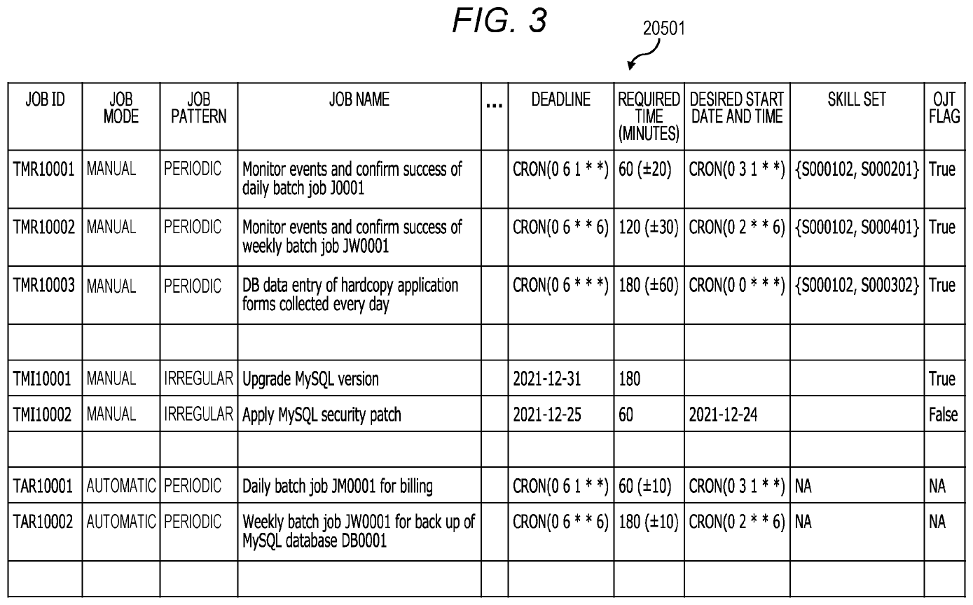

FIG. 3 is a diagram illustrating a job table.

The job table 20501 is a table that stores information regarding the job for each job. In the job table 20501, a job ID, a job mode, a job pattern, a job name, a deadline, a required time (minutes), a desired start date and time, a skill set, and an OJT flag are recorded in a record of each row in association with each other.

The job ID is identification information for identifying the job.

The job mode is information indicating whether the job is a job manually executed by the personnel or a job automatically performed by the information system 101.

The job pattern is information indicating whether the job is a job that is repeatedly executed periodically or a job that is executed irregularly.

The job name is the name of the job.

The deadline is information indicating a deadline for executing the job. As an example, the deadline of a job executed periodically is represented by a CRON tab including an initial date and time and a cycle. As an example, a deadline of a job executed irregularly is represented by date and time.

The required time (minutes) is information indicating the required time of the job in minutes. As an example, it is indicated by a standard required time and a time width allowed before and after the time.

The desired start date and time is information indicating a date and time when the job is to be started. As an example, the desired start date and time of the job executed periodically is represented by a CRON tab including an initial date and time and a cycle. As an example, the desired start date and time of the job irregularly executed is indicated by date and time.

The skill set is information indicating skills required for the job. The number of skills required for the job may be one or more. The skill is represented by identification information of the skill. The skill required for the job may be indicated by the type and level of the skill. A job executed automatically does not require personnel, and therefore does not require skill.

The OJT flag is information indicating whether the job is a job that may be assigned to an OJT. True means that it may be assigned to an OJT, and False means that it may not be assigned to an OJT. For example, critical jobs may not be assigned to OJTs. In the example of FIG. 3, since a job whose job ID is TMI10002 is an important job to which the security patch is applied, it is assumed that no OJT is assigned. NA means a job that cannot be executed by OJT. Since OJT cannot be executed, the automatically executed job is NA.

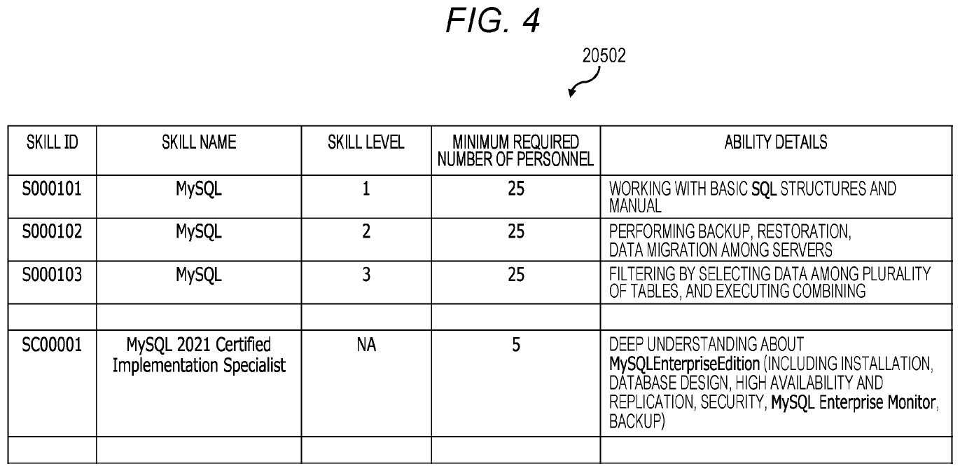

FIG. 4 is a diagram illustrating a skill table.

The skill table 20502 is a table indicating information regarding the skill for each skill. In the skill table 20502, a skill ID, a skill name, a skill level, a minimum required number of personnel, and ability details are recorded in a record of each row in association with each other.

The skill ID is identification information for identifying the skill.

The skill name is a name of the skill and indicates a type of the skill.

The skill level is information indicating the level of the skill.

The minimum required number of personnel is information indicating the minimum required number of people having the skill.

The ability details are information indicating details of the skill.

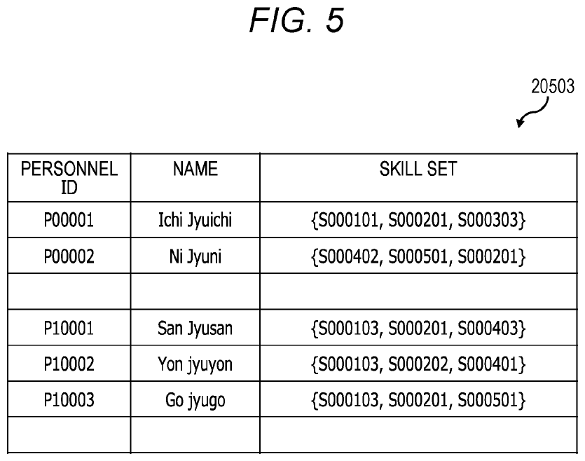

FIG. 5 is a diagram illustrating a personnel table.

The personnel table 20503 is a table indicating information regarding the personnel for each of the personnel. In the personnel table 20503, a personnel ID, a name, and a skill set are recorded in a record of each row in association with each other.

The personnel ID is identification information for identifying the personnel.

The name is the name of the personnel.

The skill set is information indicating skills possessed by the personnel. The personnel may have one skill or a plurality of skills. The skill is represented by identification information of the skill. The skill of the personnel may be indicated by the type and level of the skill.

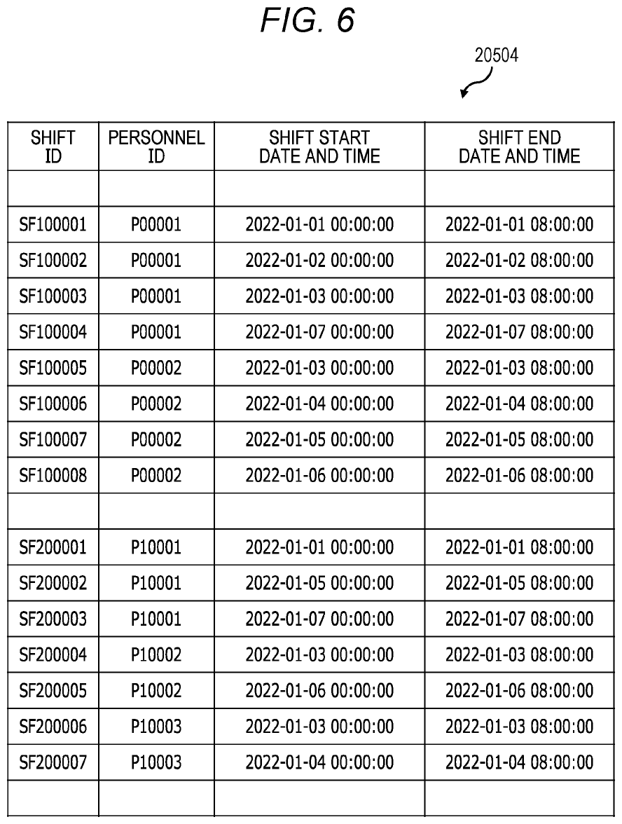

FIG. 6 is a diagram illustrating a shift table.

The shift table 20504 is information indicating a time zone in which each personnel member works. In the shift table 20504, a shift ID, a personnel ID, a shift start date and time, and a shift end date and time are stored in a record of each row in association with each other.

The shift ID is identification information for identifying a unit for each unit from the start to the end of work. The unit may be referred to as a shift.

The personnel ID is identification information for identifying personnel working in the shift.

The shift start date and time is information indicating a date and time when work starts in the shift.

The shift end date and time is information indicating a date and time at which work ends in the shift.

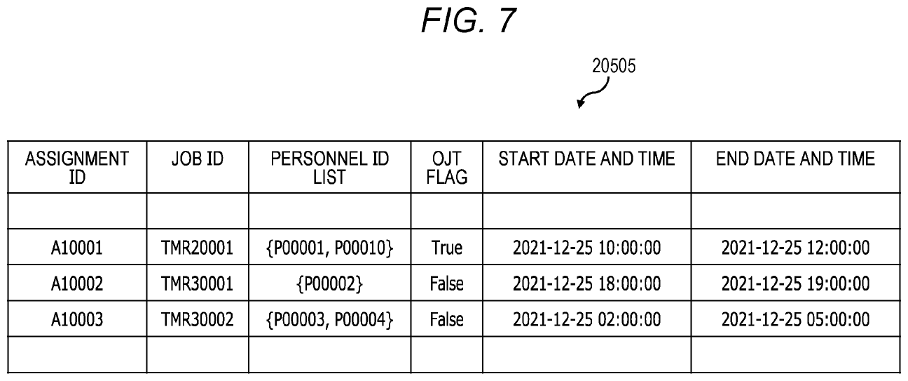

FIG. 7 is a diagram illustrating an assignment table.

The assignment table 20505 is a table that records information regarding the execution schedule of the job for each execution schedule of the job for the job to be executed. The assignment table 20505 stores, in a record of each row, an assignment ID, a job ID, a personnel ID list, an OJT flag, a start date and time, and an end date and time for the execution schedule of the job in association with each other.

The assignment ID is identification information for identifying the execution schedule of the job.

The job ID is identification information for identifying the job.

The personnel ID list is identification information for identifying personnel who execute the job.

The OJT flag is a flag indicating whether the execution schedule of the job is assigned to the OJT. True means that it is assigned to an OJT, and False means that it is not assigned to an OJT.

The start date and time is information indicating a date and time when the job is scheduled to start.

The end date and time is information indicating a date and time when the job is scheduled to end.

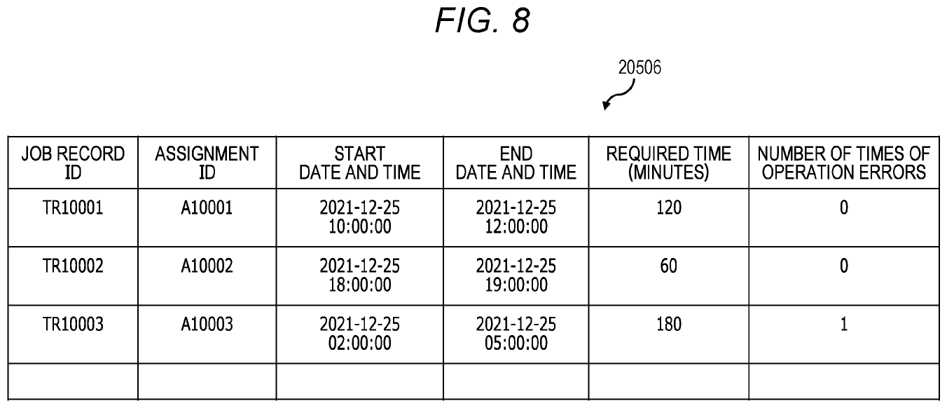

FIG. 8 is a diagram illustrating a job performance table.

The job performance table 20506 is a table in which information regarding an execution result of a job is recorded for each execution of the job for the executed job. In the job performance table 20506, a job record ID, an assignment ID, a start date and time, an end date and time, a required time (minutes), and the number of times of operation errors are recorded in a record of each row in association with each other.

The job record ID is identification information for identifying performance of a job.

The assignment ID is information indicating an assignment ID assigned to a job execution schedule corresponding to the performance of the job.

The start date and time is information indicating the date and time of the performance of starting the job.

The end date and time is information indicating the date and time of the performance of ending the job.

The required time (minutes) is information indicating the time of the performance required to execute the job in minutes.

The number of times of operation errors is information indicating the number of times of operation errors occurring in the job execution.

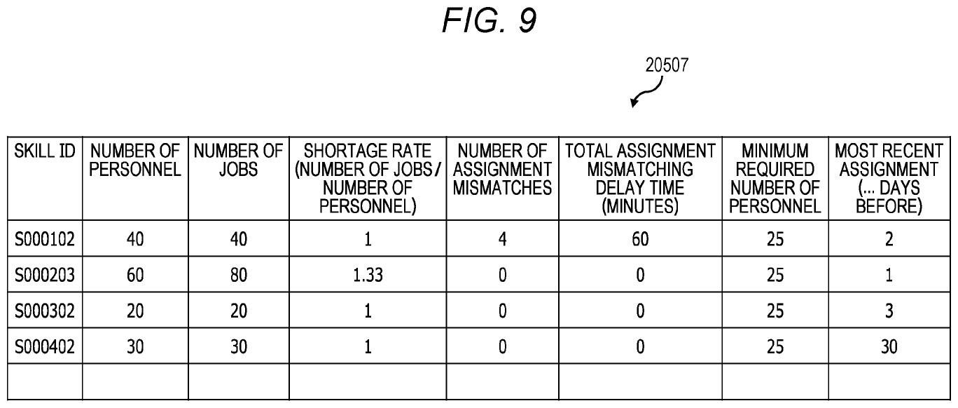

FIG. 9 is a diagram illustrating an insufficient skill table.

The insufficient skill table 20507 is a table in which information regarding the insufficient skill is recorded for each insufficient skill. In the insufficient skill table 20507, in the record of each row, the skill ID, the number of personnel, the number of jobs, the shortage rate (the number of jobs/the number of personnel), the number of assignment mismatches, the total assignment mismatching delay time (minutes), the minimum required number of personnel, and the most recent assignment ( . . . days before) are recorded in association with each other.

The skill ID is identification information for identifying the insufficient skill.

The number of personnel is information indicating the number of personnel having the insufficient skill.

The number of jobs is the number of jobs requiring the insufficient skill.

The shortage rate (the number of jobs/the number of personnel) is information indicating how many personnel are insufficient in the insufficient skill. The shortage rate (the number of jobs/the number of personnel) is calculated by dividing the number of jobs by the number of personnel. The larger the value of the shortage rate, the higher the degree of shortage of personnel.

The number of assignment mismatches is information indicating the number of times a job execution schedule cannot be created in which the desired start date and time set in the job table 20501 is set as the start date and time in the assignment table 20505 in the job requiring the insufficient skill. Hereinafter, the execution schedule of the job having the desired start date and time as the start date and time cannot be created may be referred to as an assignment mismatch.

The total assignment mismatching delay time (minutes) is information indicating, in minutes, the total value of the time in which the start date and time is delayed due to the assignment mismatch for the insufficient skill.

The minimum required number of personnel is the minimum required number of people having the insufficient skill.

The most recent assignment ( . . . days before) is information indicating the number of days that the date of the most recent date on which a job requiring the insufficient skill has been assigned to the personnel and executed is from today. For example, when a job is automated and the frequency of assignment to personnel decreases, the value of the most recent assignment ( . . . days before) of skills required for the job increases.

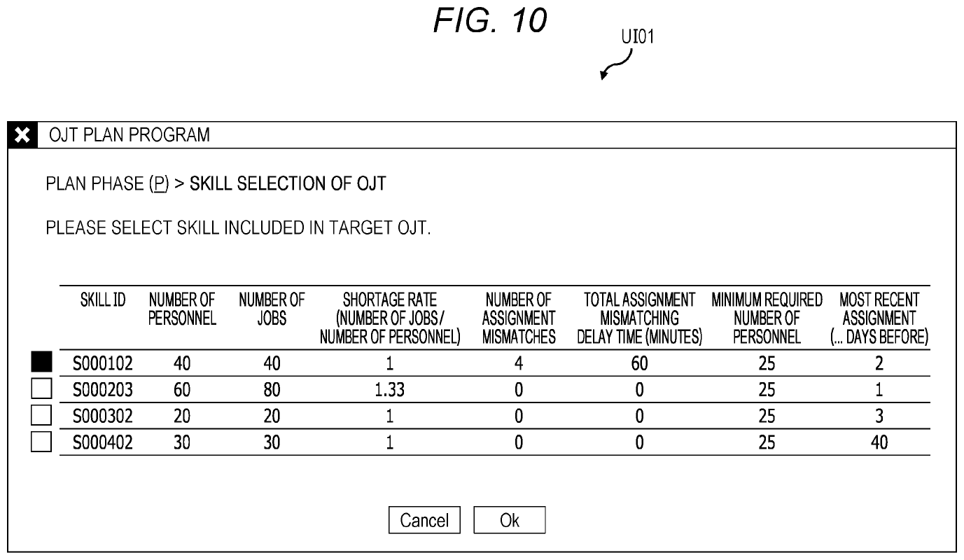

FIG. 10 is a diagram illustrating a skill selection GUI. The GUI stands for Graphical User Interface.

A skill selection GUI UI01 is a screen for the administrator to select a skill for training personnel by OJT.

In the present embodiment, the OJT job assignment server 104 presents the skill selection GUI UI01 to the administrator, and prompts the administrator to determine a skill for training personnel through OJT. When the administrator enters a check box for any one or more insufficient skills and presses an OK button, the insufficient skills are confirmed as OJT targets.

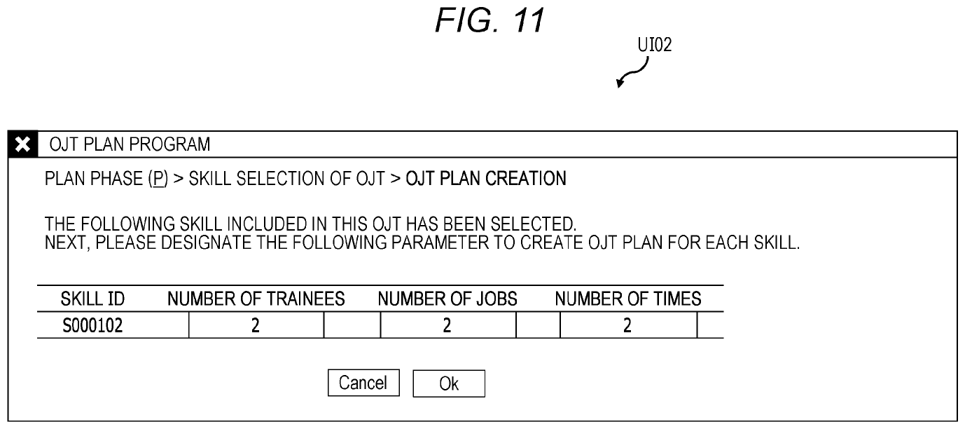

FIG. 11 is a diagram illustrating an OJT plan creation GUI.

An OJT plan creation GUI UI02 is a screen for the administrator to input parameters of the OJT. The parameter includes, as an example, the number of trainees to be trained, the number of jobs that the trainee is caused to experience, and the number of times that the trainee is caused to experience jobs.

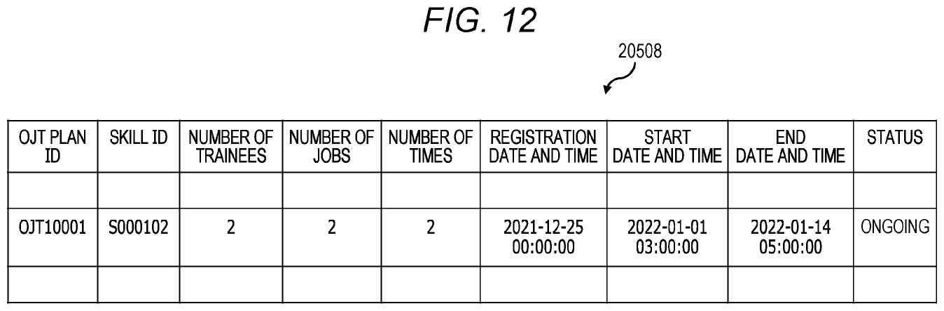

FIG. 12 is a diagram illustrating an OJT plan table.

An OJT plan table is illustrated in the drawing.

The OJT plan table 20508 is a table in which information regarding the OJT plan is registered. In the OJT plan table 20508, an OJT plan ID, a skill ID, the number of trainees, the number of jobs, the number of times, a registration date and time, a start date and time, an end date and time, and a status are registered in a record of each row in association with each other.

The OJT plan ID is identification information for identifying the OJT plan.

The skill ID is identification information for identifying a skill for training personnel in the OJT plan.

The number of trainees is information indicating the number of trainees to be trained as skilled personnel in the OJT plan.

The number of jobs is information indicating the number of jobs to be experienced by the trainee in the OJT of the OJT plan.

The number of times is information indicating the number of times a trainee is caused to experience each job in the OJT of the OJT plan.

The registration date and time is information indicating the date and time when the OJT plan is registered.

The start date and time is information indicating a date and time when the OJT according to the OJT plan is started.

The end date and time is information indicating a date and time when the OJT according to the OJT plan ends.

The status is information indicating the state of the OJT according to the OJT plan. The status includes registered, ongoing, completed, and evaluated states. The registered state is a state in which the OJT plan is registered and the OJT is not started. The ongoing state is a state in which the OJT of the OJT plan has been started and has not been finished. The completed state is a state in which the OJT of the OJT plan has ended and the result has not been evaluated. The evaluated state is a state in which the result of the OJT in the OJT plan has been evaluated.

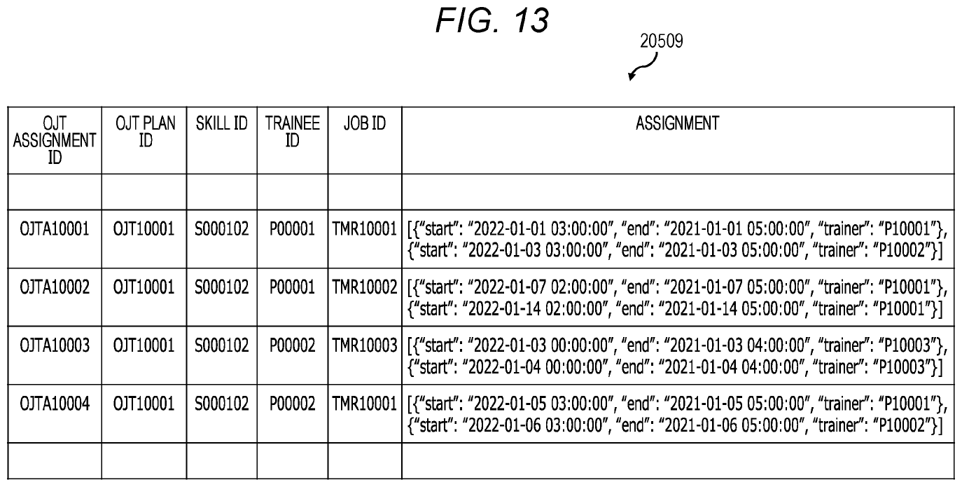

FIG. 13 is a diagram illustrating an OJT assignment table.

The OJT assignment table 20509 is a table in which information regarding each OJT included in the OJT plan is registered. One unit of OJT is defined for each trainee and job. That is, causing one trainee to experience one job as many times as necessary is one unit of OJT. In the OJT assignment table 20509, an OJT assignment ID, an OJT plan ID, a skill ID, a trainee ID, a job ID, and an assignment are registered in association with each other for each OJT.

The OJT assignment ID is identification information for identifying the OJT.

The OJT plan ID is identification information for identifying an OJT plan including the OJT.

The skill ID is identification information for identifying a skill for training personnel in the OJT.

The trainee ID is identification information for identifying a trainee trained by the OJT.

The job ID is identification information for identifying a job to be experienced by the trainee in the OJT.

The assignment is assignment information of a start date and time of a job in the OJT, an end date and time, and a trainer. For example, for an OJT that allows one trainee to experience the same job twice, two sets of assignment information of a start date and time, an end date and time, and a trainer are registered.

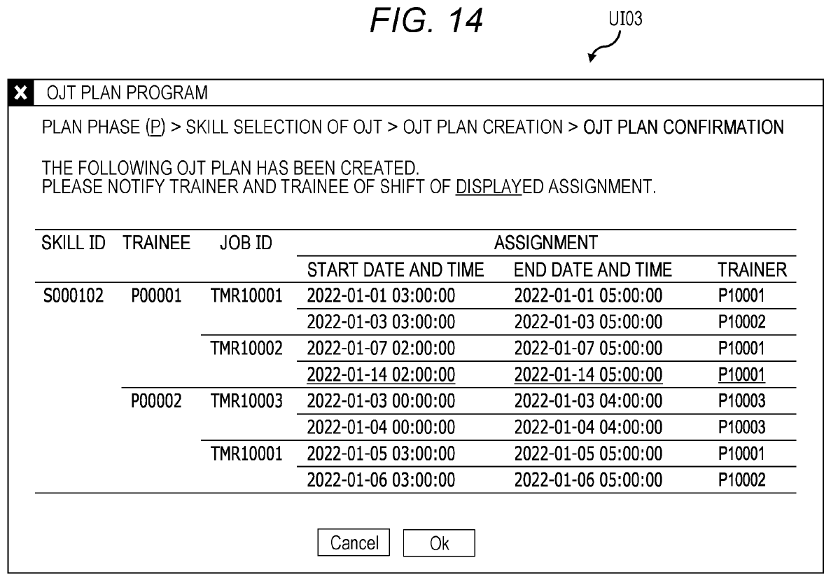

FIG. 14 is a diagram illustrating an OJT plan confirmation GUI.

An OJT plan confirmation GUI UI03 is a screen for confirming the OJT plan created by the administrator.

In the present embodiment, when the administrator confirms the content of each OJT included in the OJT plan on the OJT plan confirmation GUI UI03 and presses the OK button, the assignment of the trainer and the trainee to the job of the OJT is confirmed.

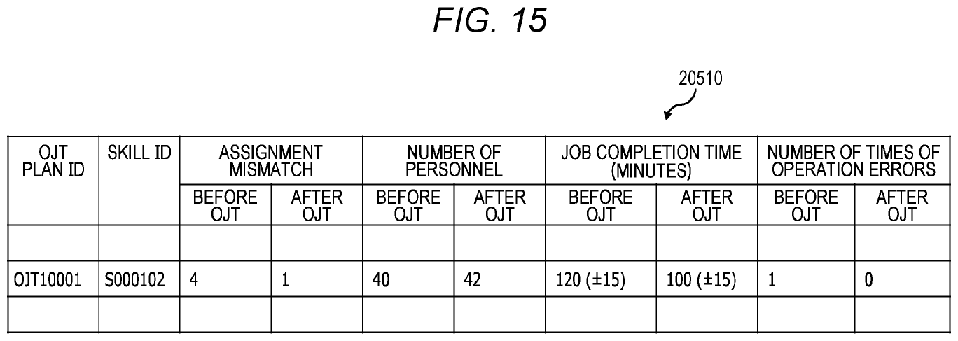

FIG. 15 is a diagram illustrating an OJT evaluation table.

The OJT evaluation table 20510 is a table in which the evaluation of the OJT according to the OJT plan is recorded. In the OJT evaluation table 20510, for each OJT plan and each skill, an OJT plan ID, a skill ID, an assignment mismatch before and after the OJT, the number of personnel before and after the OJT, a job completion time (minutes) before and after the OJT, and the number of times of operation errors before and after the OJT are recorded in the record of each row in association with each other.

The OJT plan ID is identification information for identifying the OJT plan.

The skill ID is identification information for identifying the skill.

The assignment mismatch before and after the OJT is information indicating the number of assignment mismatches before and after the OJT is executed for the OJT and the skill.

The number of personnel before and after the OJT is information indicating the number of personnel before and after the OJT for the OJT and the skill.

The job completion time (minutes) before and after the OJT is information indicating, in minutes, average values and standard deviations of the job completion time before and after the OJT is executed for the OJT and the skill.

The number of times of operation errors before and after the OJT is information indicating the number of times of operation errors before and after the OJT is executed for the OJT and the skill.

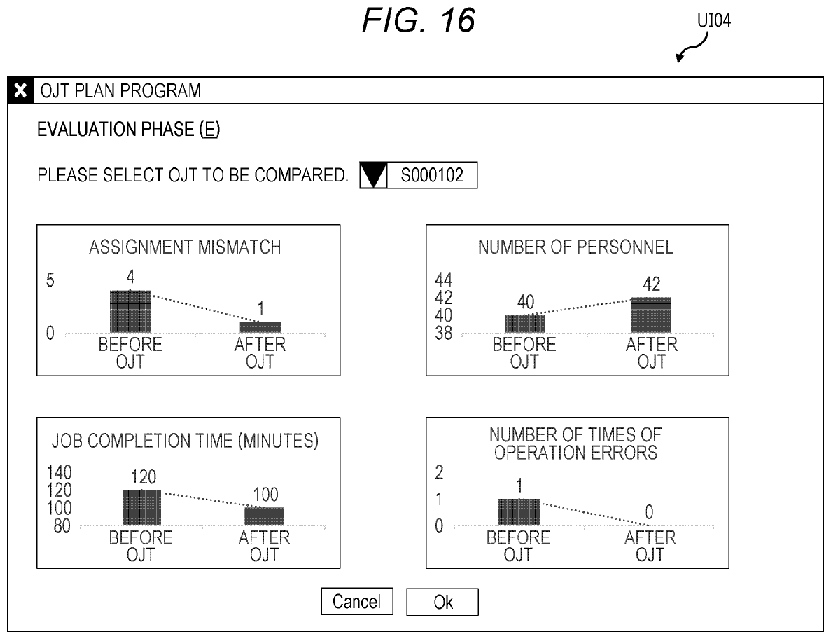

FIG. 16 is a diagram illustrating an OJT evaluation GUI.

An OJT evaluation GUI UI04 is a screen for evaluating the result of the OJT of the OJT plan created by the administrator. In the present embodiment, regarding the OJT selected by the administrator, the assignment mismatch before and after the OJT, the number of personnel before and after the OJT, the job completion time (minutes) before and after the OJT, and the number of times of operation errors before and after the OJT are displayed in a graph.

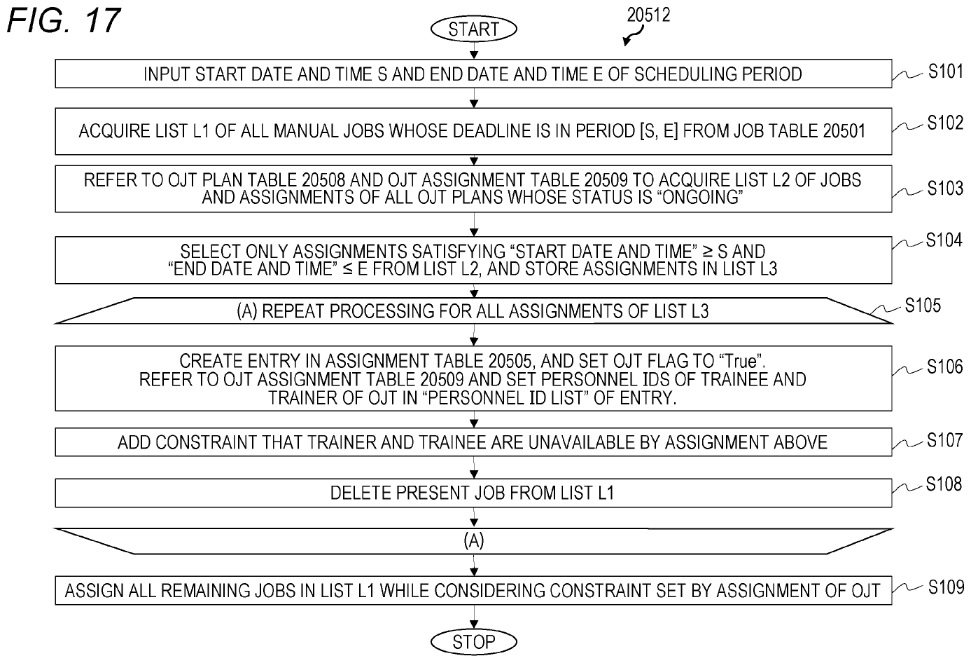

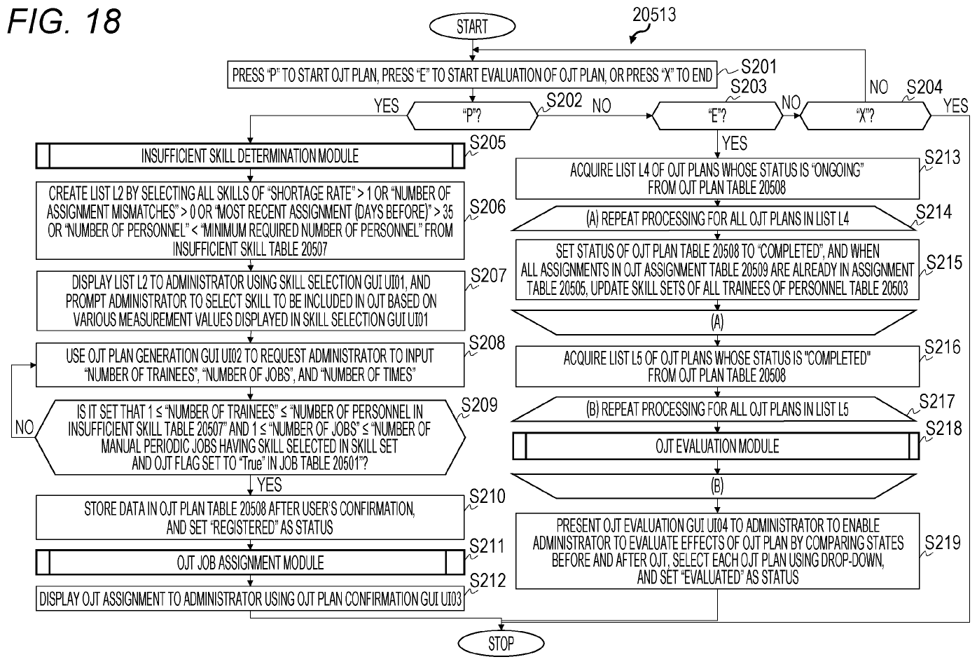

FIG. 17 is a flowchart of processing by the job assignment program. FIGS. 18 to 23 are flowcharts of processing by the OJT planning program. The processing by the OJT planning program 20513 includes processing of creating an OJT plan and processing of evaluating a result of the OJT. After the processing of creating the OJT plan by the OJT planning program 20513, processing of assigning a job by the job assignment program 20512 is performed. Then, after the OJT is actually executed, processing by a program for evaluating a result of the OJT by the OJT planning program 20513 is performed.

As described above, since the OJT plan is created before the processing of the job assignment program 20512 illustrated in FIG. 17, in the processing of the job assignment program 20512, first, the assignment of personnel and the like to the job defined in the OJT plan is reflected, and then, the personnel is assigned to the remaining job.

Referring to FIG. 17, in step S101, the processor 202 inputs a start date and time S and an end date and time E of the scheduling period in which the job is assigned based on the operation by the administrator. Next, in step S102, the processor 202 acquires all the manual jobs whose deadline is in the period [S, E] from the job table 20501, and creates the acquired job list L1. Next, in step S103, the processor 202 refers to the OJT plan table 20508 and the OJT assignment table 20509 to acquire the jobs and assignments of all the OJT plans whose status is “ongoing”, and creates a list L2 thereof. Next, in step S104, the processor 202 selects only the assignment satisfying “start date and time” S and “end date and time” E from the list L2, and creates a list L3 of the selected assignment.

Subsequently, the processor 202 repeats the processing of the following steps S106 to S108 for all the assignments of the list L3 (step S105).

In step S106, the processor 202 creates an entry in the assignment table 20505 and sets the OJT flag to “true”. Further, the processor 202 refers to the OJT assignment table 20509 and sets the personnel IDs of the trainee and the trainer of the OJT in the “personnel ID list” of the entry. Since the trainer and the trainee become unavailable due to the assignment of the OJT, the processor 202 sets a constraint of the unavailability in step S107. Further, in step S108, the processor 202 deletes the job from the list L1.

When the processing of steps S106 to S108 ends for all the assignments in the list L3, in step S109, the processor 202 assigns personnel to all the remaining jobs in the list L1 while considering the constraint set by the assignment of the OJT.

FIG. 18 is a flowchart of processing by the OJT planning program.

In step S201, the processor 202 displays a start screen (not illustrated) of the OJT plan and receives an input from the administrator. The start screen includes a “P” button for starting the OJT plan, an “E” button for starting evaluation of the OJT plan, and an “X” button for ending work.

In step S202, the processor 202 determines whether “P” has been pressed. When “P” is pressed, the processor 202 executes processing of the insufficient skill determination module in step S205. The processing of the insufficient skill determination module is processing of creating the insufficient skill table 20507.

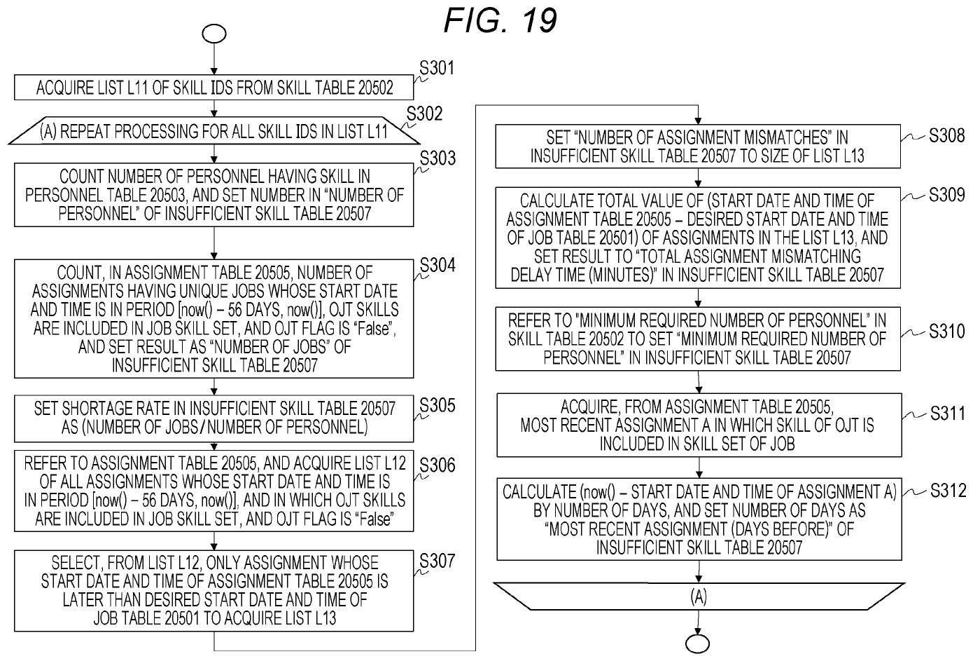

FIG. 19 is a flowchart of processing of the insufficient skill determination module.

In step S301, the processor 202 acquires a list L11 of skill IDs from the skill table 20502. Subsequently, the processor 202 repeats the processing of the following steps S303 to S312 for all the skill IDs in the list L11 (step S302).

In step S303, the processor 202 counts the number of personnel having the skill in the personnel table 20503, and sets the number in the “number of personnel” of the insufficient skill table 20507.

Next, in step S304, the processor 202 counts, in the assignment table 20505, the number of assignments having unique jobs whose start date and time is in a period [now( )−56 days, now( )], OJT skills are included in a job skill set, and the OJT flag is “false”. now( ) is the current date and time. Here, 56 days, that is, 8 weeks is an example, and other periods may be used. Here, the number of jobs requiring the skill is counted. Then, the processor 202 sets the number of job assignments as the count result to the “number of jobs” in the insufficient skill table 20507.

Next, in step S305, the processor 202 calculates the number of jobs/the number of personnel, and sets the number of jobs/the number of personnel as a shortage rate in the insufficient skill table 20507.

Next, in step S306, the processor 202 refers to the assignment table 20505, acquires all the assignments in which the start date and time is in the period [now( )−56 days, now( )], the skill of the OJT target is included in the skill set of the job, and the OJT flag is “false”, and creates a list L12 thereof.

Next, in step S307, the processor 202 selects, from the list L12, only the assignment whose start date and time of the assignment table 20505 is later than the desired start date and time of the job table 20501, and creates a list L13 thereof. The list L13 created here is a list of assignments in which an assignment mismatch has occurred. Next, in step S308, the processor 202 sets the “number of assignment mismatches” in the insufficient skill table 20507 to the size of the list L13.

Next, in step S309, the processor 202 calculates a total value of (the start date and time of the assignment table 20505—the desired start date and time of the job table 20501) of the assignments in the list L13. Then, the processor 202 sets the calculated total value to “total assignment mismatching delay time (minutes)” in the insufficient skill table 20507.

Next, in step S310, the processor 202 refers to the “minimum required number of personnel” in the skill table 20502 to set the “minimum required number of personnel” in the insufficient skill table 20507.

Next, in step S311, the processor 202 acquires, from the assignment table 20505, the most recent assignment A in which the skill of the OJT is included in the skill set of the job. Further, in step S312, the processor 202 calculates (now( )−start date and time of assignment A) by the number of days, and sets the number of days as the “most recent assignment (days before)” of the insufficient skill table 20507.

Returning to FIG. 18, next, in step S206, the processor 202 creates a skill list L2 by selecting all skills of “shortage rate”>1 or “number of assignment mismatches”>0 or “most recent assignment (days before)”>35 or “number of personnel”<“minimum required number of personnel” from the insufficient skill table 20507.

Next, in step S207, the processor 202 displays the list L2 to the administrator using the skill selection GUI U101, and prompts the administrator to select a skill to be included in the OJT. As illustrated in FIG. 10, the administrator checks the check box of the skill to be included in the OJT based on the various measured values displayed in a skill selection GUI U101, and presses the “OK” button.

In the example of FIG. 10, four skills are displayed. The skill with the skill ID S000102 is displayed because the number of assignment mismatches is 4. The skill with the skill ID S000203 is displayed because the shortage rate is 1.33. The skill with the skill ID S000302 is displayed because the number of personnel is 20 and is smaller than the minimum required number of personnel of 25. The skill with the skill ID S000402 is displayed because the most recent assignment is 40 days before and is longer than the reference 35 days, and there is no personnel who has executed the job requiring the skill for a long period of time. The reference 35 days is an example, and other days may be used. Here, the skill with the skill ID S000102 is selected as an OJT target.

Next, in step S208, the processor 202 uses an OJT plan generation GUI UI02 to request the administrator to input the “number of trainees”, the “number of jobs”, and the “number of times” for each skill selected in step S207. As illustrated in FIG. 11, the OJT plan generation GUI UI02 has input fields for each of the “number of trainees”, the “number of jobs”, and the “number of times”. Here, 2 is input for each of the number of trainees, the number of jobs, and the number of times.

Next, in step S209, the processor 202 checks whether a normal value is input in step S208. Specifically, if 1≤“the number of trainees”≤“the number of personnel in the insufficient skill table 20507” and 1≤“the number of jobs”≤“the number of manual periodic jobs having the selected skill in the skill set and the OJT flag set to “true” in the job table 20501”, it is determined to be normal. If an abnormal value has been input, the processor 202 returns to step S208.

When it is determined in step S209 that a normal value has been input, next, in step S210, the processor 202 creates an entry in which a new OJT plan ID is assigned in the OJT plan table 20508 as data after confirmation by the administrator, sets S000102 as the skill ID of the entry, sets 2 as the number of trainees, sets 2 as the number of jobs, sets 2 as the number of times, sets the current date and time as the registration date and time, and sets “registered” as the status.

Next, in step S211, the processor 202 executes processing of the OJT job assignment module. The processing of the OJT job assignment module is processing of determining a trainee to be trained in the OJT, a job to be used for the OJT, and a trainer to be a coach in the OJT. In other words, the processing of the OJT job assignment module is processing of creating the OJT assignment table 20509 illustrated in FIG. 13.

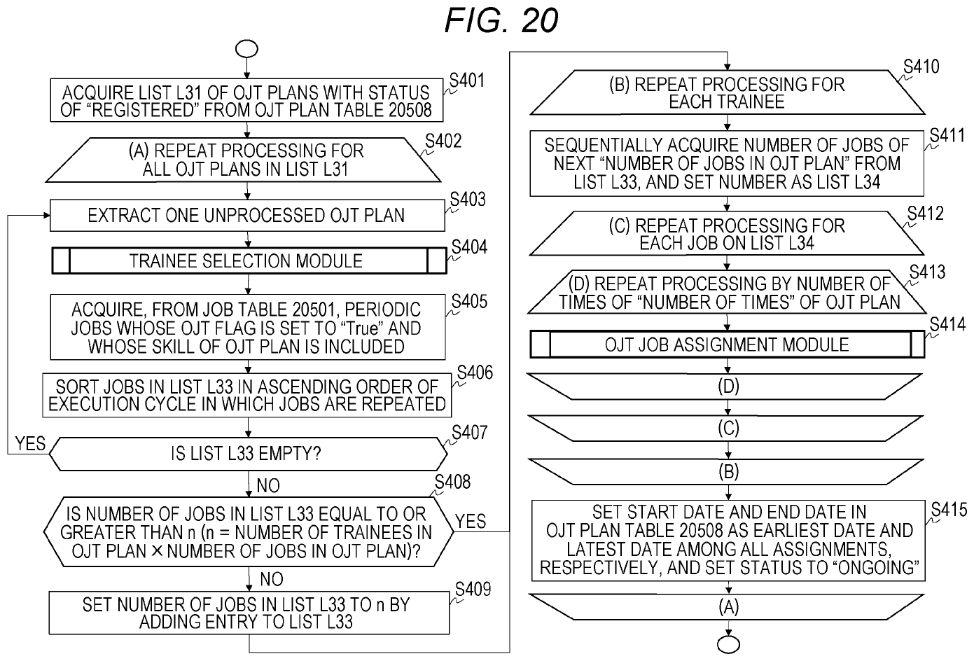

FIG. 20 is a flowchart of processing of the OJT job assignment module.

In step S401, the processor 202 acquires a list L31 of OJT plans with the status of “registered” from the OJT plan table 20508.

Subsequently, the processor 202 repeats the processing of the following steps S403 to S415 for all the OJT plans in the list L31 (step S402).

In step S403, the processor 202 extracts one unprocessed OJT plan from the list L31. Next, in step S404, the processor 202 executes processing of the trainee selection module. The processing of the trainee selection module is processing of selecting a trainee to be trained by the OJT.

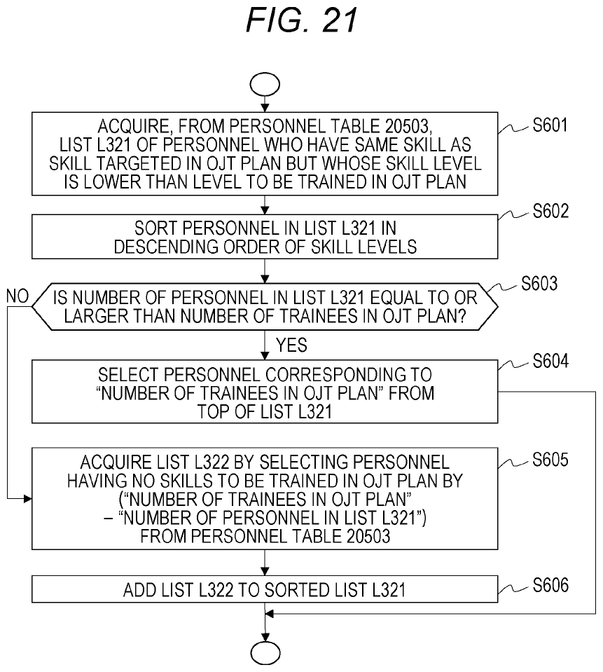

FIG. 21 is a flowchart of processing of the trainee selection module.

In step S601, the processor 202 acquires, from the personnel table 20503, a list L321 of personnel who have the same skill as the skill targeted in the OJT plan but whose skill level is lower than the level to be trained in the OJT plan. Next, in step S602, the processor 202 sorts the personnel in the list L321 in descending order of skill levels.

Next, in step S603, the processor 202 determines whether the number of personnel in the list L321 is equal to or larger than the number of trainees in the OJT plan. If the number of personnel in the list L321 is equal to or larger than the number of trainees in the OJT plan, the processor 202 selects, in step S604, personnel corresponding to the “number of trainees in the OJT plan” from the top of the list L321 as OJT targets and ends the processing.

If the number of personnel in the list L321 is smaller than the number of trainees in the OJT plan, in step S605, the processor 202 creates a list L322 of personnel by selecting personnel who do not have skills to be trained in the OJT plan (“the number of trainees in the OJT plan”−“the number of personnel in the list L321”) from the personnel table 20503. At this time, a method of selecting personnel is not particularly limited, and for example, selection may be performed randomly.

Next, in step S606, the processor 202 adds the list L322 to the sorted list L321 to determine personnel to be OJT targets.

As described above, in the processing of the trainee selection module, personnel who have the same skill as the skill targeted for the OJT plan but whose skill level is lower than the level to be trained in the OJT plan are prioritized, and among them, personnel with a high level are prioritized and selected as trainees to be trained in the OJT. This makes it possible to prioritize personnel who reach a desired skill in the OJT plan at an early stage to a desired level and to quickly develop personnel who have the desired skill at the desired level.

Returning to FIG. 20, in step S405, the processor 202 creates a job list L33 by manually extracting, from the job table 20501, periodic jobs whose OJT flag is set to “true” and whose skill set includes the skill of the OJT plan. Next, in step S406, the processor 202 sorts the jobs in the list L33 in ascending order of the execution cycle in which the jobs are repeated.

Next, in step S407, the processor 202 determines whether the list L33 is empty. When the list L33 is empty, the processor 202 returns to step S403.

If the list L33 is not empty, then in step S408, the processor 202 determines whether the number of jobs in the list L33 is equal to or greater than n (n=the number of trainees in the OJT plan×the number of jobs in the OJT plan).

If the number of jobs in the list L33 is smaller than n, next, in step S409, the processor 202 sets the number of jobs in the list L33 to n by manually selecting irregular jobs whose OJT flag is set to “true” and whose skill set includes OJT planning skills, from the job table 20501 and adding the irregular jobs to the list L33.

Subsequently, the processor 202 repeats the processing of the following steps S411 to S414 for all the trainees in the list L321 (step S402).

In step S411, the processor 202 sequentially acquires the number of jobs of the next “number of jobs in the OJT plan” from the list L33, and sets the acquired number of jobs as a list L34.

Subsequently, the processor 202 repeats the processing of step S414 for the “number of times” of the OJT plan for each job of the list L34.

Step S414 is processing of the OJT job assignment module. The processing of the OJT job assignment module is processing of determining a trainer of the OJT.

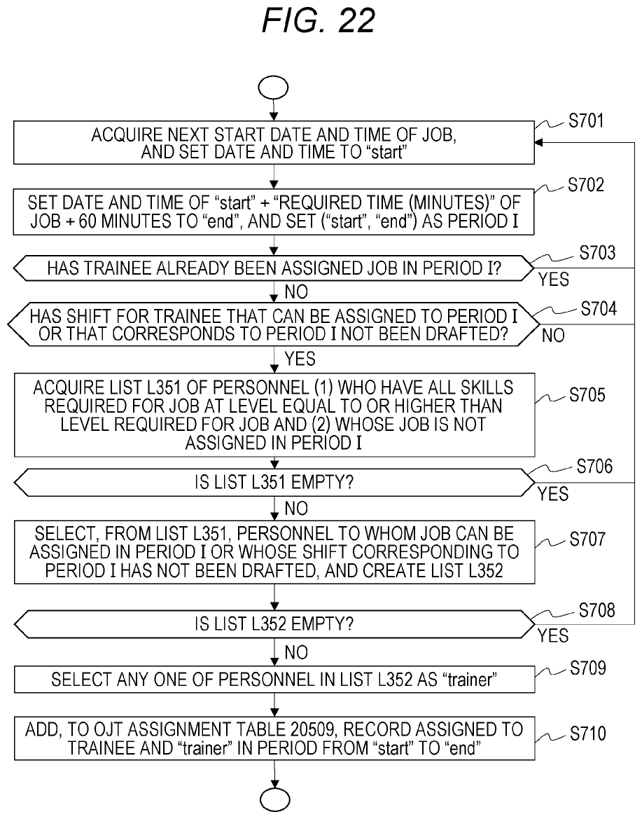

FIG. 22 is a flowchart of processing of the OJT job assignment module 2.

In step S701, the processor 202 acquires the next start date and time of the job, and sets the date and time to “Start”. Next, in step S702, the processor 202 sets the date and time of “Start”+“required time (minutes)” of the job+60 minutes to “End”, and sets (“Start”, “End”) as a period I.

Next, in step S703, the processor 202 determines whether the trainee has already been assigned a job in the period I. If the trainee has already been assigned some jobs in the period I, the trainee cannot participate in the OJT in the period I, and thus the processor 202 returns to step S701 and further acquires the next start date and time.

If the trainee has not yet been assigned a job in the period I, then in step S704 the processor 202 checks whether a shift for the trainee that can be assigned to the period I or that corresponds to the period I has not been drafted. If the trainee is not assignable to the period I or a shift corresponding to the period I is not yet drafted, the trainee cannot participate in the OJT in the period I, and thus the processor 202 returns to step S701 to acquire the next start date and time of the job.

If the trainee can be assigned to the period I or the shift of the trainee corresponding to the period I has not been drafted, next, in step S705, the processor 202 acquires a list L351 of personnel (1) who have all skills required for the job at a level equal to or higher than the level required for the job and (2) whose job is not assigned in the period I. The personnel of the list L351 is personnel having a skill to be a trainer. Next, in step S706, the processor 202 determines whether the list L351 is empty. When the list L351 is empty, the processor 202 returns to step S701.

If the list L351 is not empty, next, in step S707, the processor 202 selects, from the list L351, personnel to whom a job can be assigned in the period I or whose shift corresponding to the period I has not been drafted, and creates a list L352. The personnel in the list L352 is the personnel who can participate in the OJT in the period I as a trainer. Next, in step S706, the processor 202 determines whether the list L352 is empty. When the list L352 is empty, the processor 202 returns to step S701.

When the list L352 is not empty, next, in step S709, the processor 202 selects any one of the personnel in the list L352 as a “trainer” of the OJT. Next, in step S710, the processor 202 adds, to the OJT assignment table 20509, the record of the OJT to which the job is assigned to the trainee and the trainer in the period from “Start” to “End”.

Returning to FIG. 20, when the job, trainee, and trainer of the OJT for the OJT plan are determined, in step S415, the processor 202 sets the start date and the end date of the OJT plan in the OJT plan table 20508 as the earliest date and the latest date among all the assignments of OJT according to the OJT plan, respectively, and sets the status to “ongoing”.

Returning to FIG. 18, since the processing of the OJT job assignment module in step S211 is completed, the processor 202 displays the OJT assignment to the administrator using the OJT plan confirmation GUI UI03 in step S212. In the example of the OJT plan confirmation GUI UI03 illustrated in FIG. 14, assignment is performed such that two trainees experience two jobs twice each.

This completes a series of processing of the OJT plan.

Next, evaluation processing after the OJT is performed will be described.

If “P” has not been pressed in step S202, the processor 202 determines whether “E” has been pressed in step S203. When “E” has been pressed, in step S213, the processor 202 acquires a list L4 of OJT plans with a status of “ongoing” from the OJT plan table 20508.

Subsequently, the processor 202 repeats the processing in step S215 for all the OJT plans in the list L4 (step S214).

In step S215, the processor 202 sets the status of the OJT plan in the OJT plan table 20508 to “completed”. Further, when all the assignments in the OJT assignment table 20509 are already in the assignment table 20505 and have been completed, the trainee has experienced all the OJT scheduled in the OJT plan, and thus has acquired the desired skill to the desired level. Therefore, the processor 202 updates the skill sets of all the trainees in the personnel table 20503.

Next, in step S216, the processor 202 acquires a list L5 of OJT plans whose status is “completed” from the OJT plan table 20508.

Subsequently, the processor 202 repeats the processing of the OJT evaluation module in step S218 for all the OJT plans in the list L5 (step S217).

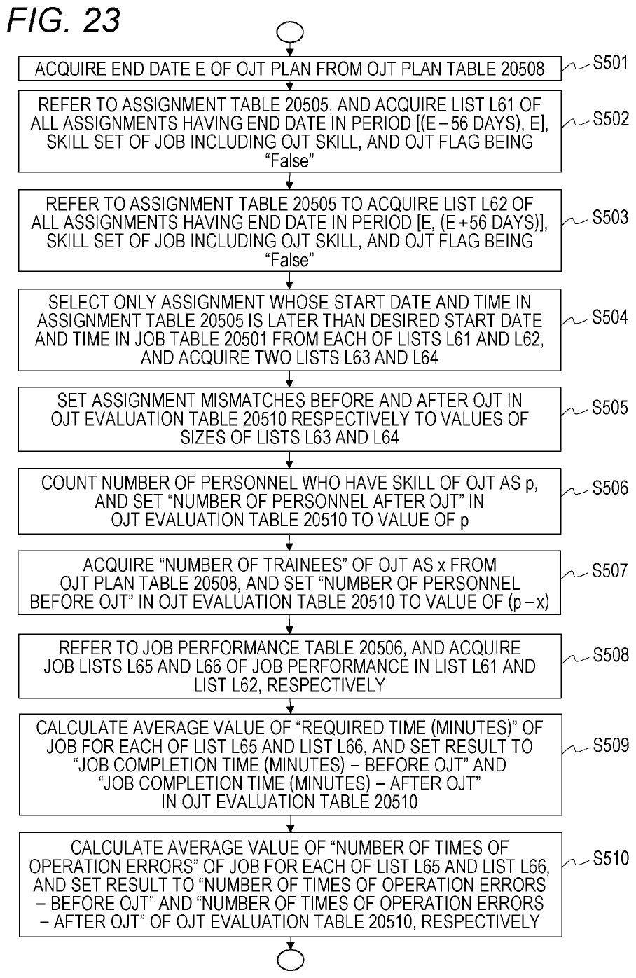

FIG. 23 is a flowchart of processing of an OJT evaluation module.

In step S501, the processor 202 acquires the end date E of the OJT plan from the OJT plan table 20508.

Next, in step S502, the processor 202 refers to the assignment table 20505, and acquires a list L61 of all assignments having the end date in the period [(E−56 days), E], the skill set of the job including the OJT skill, and the OJT flag being “false”. In step S503, the processor 202 refers to the assignment table 20505 to acquire the list L62 of all assignments having the end date in the period [E, (E+56 days)], the skill set of the job including the OJT skill, and the OJT flag being “false”. Here, 56 days, that is, 8 weeks is an example of the evaluation target period, and other periods may be used.

Next, in step S504, the processor 202 selects only an assignment whose start date and time in the assignment table 20505 is later than the desired start date and time in the job table 20501 from each of the lists L61 and L62, and acquires lists L63 and L64.

Next, in step S505, the processor 202 sets the values of the sizes of the lists L63 and L64 to the assignment mismatches before and after the OJT in the OJT evaluation table 20510, respectively.

Next, in step S506, the processor 202 counts the number of personnel who have the skill of OJT according to the OJT plan (the number of personnel at the time of executing the evaluation) as p, and sets the “number of personnel after OJT” in the OJT evaluation table 20510 to a value of p.

Next, in step S507, the processor 202 acquires the “number of trainees” of the OJT as x from the OJT plan table 20508, and sets a value of (p−x) to the “number of personnel before OJT” in the OJT evaluation table 20510.

Next, in step S508, the processor 202 refers to the job performance table 20506, and acquires job lists L65 and L66 for which performance information is obtained among the jobs in the list L61 and the list L62, respectively.

Next, in step S509, the processor 202 calculates the average value of the “required time (min)” of the job for each of the list L65 and the list L66, and sets the results thereof to “job completion time (min)−before OJT” and “job completion time (min)−after OJT” in the OJT evaluation table 20510.

Next, in step S510, the processor 202 calculates the average value of the “number of times of operation errors” of the job for each of the list L65 and the list L66, and sets the results thereof in “number of times of operation errors−before OJT” and “number of times of operation errors−after OJT” of the OJT evaluation table 20510, respectively.

Returning to FIG. 18, when the processing of the OJT evaluation module for all the OJT plans on the list L5 is completed, next, in step S219, the processor 202 presents the evaluation of the OJT plan to the administrator using the OJT evaluation GUI UI04. Then, when the evaluation of the OJT plan is calculated and presented to the administrator, the processor 202 sets the status of the OJT plan in the OJT plan table 20508 to “evaluated”.

In the example of the OJT evaluation GUI UI04 illustrated in FIG. 16, the administrator can select an OJT or a skill using a drop-down and evaluate the effect of the OJT by comparing states before and after the OJT.

The present embodiment is an example for description of the present invention, and is not intended to limit the scope of the present invention only to those embodiments. A person skilled in the art can implement the present invention in various other aspects without departing from the scope of the present invention.

The present embodiment includes the following items. However, the matters included in the present embodiment are not limited to those described below.

(Item 1)

A personnel management system for managing personnel who execute jobs requiring skill, the system including: a storage device that stores management information and a software program; and a processor that refers to the management information and executes the software program, in which the management information includes job information, for each job, indicating a date and time when the job is to be executed and a skill required for the job, job performance information, for each job, recording a date and time when the job is actually executed and an execution result of the job, skill information, for each skill, indicating a required number of personnel having the skill, and personnel information, for each personnel, indicating a skill possessed by the personnel, and the processor specifies an insufficient skill that is a skill in which personnel are insufficient based on the management information, creates an OJT plan defining a trainee, a trainer, and a job, and determining an OJT that causes the trainee to acquire the insufficient skill by executing the job with the trainer and the trainee, and compares execution results of the job related to the insufficient skill and/or the number of personnel having the insufficient skill before and after the OJT is executed.

According to this, it is possible to perform management so as to secure personnel having skills necessary for the job.

(Item 2)

In the personnel management system described in Item 1, in which the processor specifies, for each skill, the insufficient skill based on at least one of a degree of shortage of personnel for a job based on the number of personnel with the skill in the personnel information and the number of jobs requiring the skill in the job information, a degree of assignment that is delayed in execution based on a date and time when the job requiring the skill in the job information is to be executed and a date and time when the job is actually executed in the job performance information, a degree of shortage of personnel with the skill in the personnel information, and an elapsed period from execution of the job requiring the skill by the personnel.

According to this, when the job is automated and the opportunity for the personnel to manually execute is reduced, there is a concern that the skill of the personnel will be lowered. However, since the skill in which the period in which the personnel is not assigned and executed becomes long is extracted as the insufficient skill, it is possible to specify the skill in which the personnel is insufficient including the lowering of the skill due to the automation.

(Item 3)

In the personnel management system described in Item 1, in which the personnel information is information that enables determination of a type and a level of skills possessed by personnel, the job information is information that enables determination of a type and a level of a skill required for a job, and the processor refers to the personnel information and the job information, and sets personnel who has the same type of skill as the insufficient skill but whose skill level is lower than a level required for the job as the trainee.

According to this, by preferentially selecting, as a trainee, personnel who has the same type of skill as the insufficient skill but does not reach a necessary level, it is possible to quickly develop personnel who has a desired skill at a desired level.

(Item 4)

In the personnel management system described in Item 1, in which the job information is information capable of determining whether the job is a job that is manually executed, whether the job is a job that is repeatedly executed periodically, and whether the job is a cycle in which the job is repeatedly executed, and the processor targets the OJT with a job that is manually executed and periodically and repeatedly executed, and preferentially assigns a job with a shorter period to the OJT among the targets.

According to this, it is possible to execute an OJT at an early stage and quickly train personnel by selecting, as a job to be preferentially used for OJT, a job to be periodically and repeatedly executed among jobs to be manually executed.

(Item 5)

In the personnel management system described in Item 1, in which the job information is information capable of determining a required time required for the job, and the processor assigns, to the OJT, a time obtained by adding a predetermined margin time to a required time of a job for the job of the OJT.

(Item 6)

In the personnel management system described in Item 5, in which the management information further includes assignment information indicating personnel executing the job and a date and time for each job, and the processor refers to the personnel information and the assignment information, and determines, as a trainer of the OJT, personnel who has a skill required for a job of the OJT at a level required for the job and to which no other job is assigned at a time assigned to the OJT.

(Item 7)

In the personnel management system described in Item 1, in which the execution results of the job related to the insufficient skill include at least one of an assignment mismatch in which a date and time when the job is actually executed is delayed from a date and time when the job requiring the insufficient skill is to be executed, a job completion time required to execute the job, and the number of times of operation errors occurring in the execution of the job.

(Item 8)

In the personnel management system described in Item 1, in which the processor displays a screen that enables comparison between before and after the OJT is executed for a job execution result related to the insufficient skill and/or the number of personnel having the insufficient skill.

What is claimed is:

1. A personnel management system for managing personnel who execute jobs requiring skill, the system comprising:
a storage device that stores management information and a software program; and
a processor that refers to the management information and executes the software program,
wherein
the management information includes job information, for each job, indicating a date and time when the job is to be executed and a skill required for the job, job performance information, for each job, recording a date and time when the job is actually executed and an execution result of the job, skill information, for each skill, indicating a required number of personnel having the skill, and personnel information, for each personnel, indicating a skill possessed by the personnel, and
the processor specifies an insufficient skill that is a skill in which personnel are insufficient based on the management information, creates an OJT plan defining a trainee, a trainer, and a job, and determining an OJT that causes the trainee to acquire the insufficient skill by executing the job with the trainer and the trainee, and compares execution results of the job related to the insufficient skill and/or a number of personnel having the insufficient skill before and after the OJT is executed.

2. The personnel management system according to claim 1, wherein the processor specifies, for each skill, the insufficient skill based on at least one of a degree of shortage of personnel for a job based on the number of personnel with the skill in the personnel information and the number of jobs requiring the skill in the job information, a degree of assignment that is delayed in execution based on a date and time when the job requiring the skill in the job information is to be executed and a date and time when the job is actually executed in the job performance information, a degree of shortage of personnel with the skill in the personnel information, and an elapsed period from execution of the job requiring the skill by the personnel.

3. The personnel management system according to claim 1, wherein
the personnel information is information that enables determination of a type and a level of skills possessed by personnel,
the job information is information that enables determination of a type and a level of a skill required for a job, and
the processor refers to the personnel information and the job information, and sets personnel who has the same type of skill as the insufficient skill but whose skill level is lower than a level required for the job as the trainee.

4. The personnel management system according to claim 1, wherein
the job information is information capable of determining whether the job is a job that is manually executed, whether the job is a job that is repeatedly executed periodically, and whether the job is a cycle in which the job is repeatedly executed, and
the processor targets the OJT with a job that is manually executed and periodically and repeatedly executed, and preferentially assigns a job with a shorter period to the OJT among the targets.

5. The personnel management system according to claim 1, wherein
the job information is information capable of determining a required time required for the job, and
the processor assigns, to the OJT, a time obtained by adding a predetermined margin time to a required time of a job for the job of the OJT.

6. The personnel management system according to claim 5, wherein
the management information further includes assignment information indicating personnel executing the job and a date and time for each job, and
the processor refers to the personnel information and the assignment information, and determines, as a trainer of the OJT, personnel who has a skill required for a job of the OJT at a level required for the job and to which no other job is assigned at a time assigned to the OJT.

7. The personnel management system according to claim 1, wherein the execution results of the job related to the insufficient skill include at least one of an assignment mismatch in which a date and time when the job is actually executed is delayed from a date and time when the job requiring the insufficient skill is to be executed, a job completion time required to execute the job, and a number of times of operation errors occurring in the execution of the job.

8. The personnel management system according to claim 1, wherein the processor displays a screen that enables comparison between before and after the OJT is executed for a job execution result related to the insufficient skill and/or the number of personnel having the insufficient skill.

9. A personnel management method in a computer that is a personnel management system for managing personnel who execute jobs requiring skill, the computer including: a storage device that stores management information and a software program; and a processor that refers to the management information and executes the software program, wherein the management information includes job information, for each job, indicating a date and time when the job is to be executed and a skill required for the job, job performance information, for each job, recording a date and time when the job is actually executed and an execution result of the job, skill information, for each skill, indicating a required number of personnel having the skill, and personnel information, for each personnel, indicating a skill possessed by the personnel, the processor being configured to execute:
specifying an insufficient skill that is a skill in which personnel are insufficient based on the management information;
creating an OJT plan defining a trainee, a trainer, and a job, and determining an OJT that causes the trainee to acquire the insufficient skill by executing the job with the trainer and the trainee; and
comparing execution results of the job related to the insufficient skill and/or the number of personnel having the insufficient skill before and after the OJT is executed.

10. A personnel management program in a computer that is a personnel management system for managing personnel who execute jobs requiring skill, the computer including: a storage device that stores management information and a software program; and a processor that refers to the management information and executes the software program, wherein the management information includes job information, for each job, indicating a date and time when the job is to be executed and a skill required for the job, job performance information, for each job, recording a date and time when the job is actually executed and an execution result of the job, skill information, for each skill, indicating a required number of personnel having the skill, and personnel information, for each personnel, indicating a skill possessed by the personnel, the personnel management program causing the processor to execute:
specifying an insufficient skill that is a skill in which personnel are insufficient based on the management information;
creating an OJT plan defining a trainee, a trainer, and a job, and determining an OJT that causes the trainee to acquire the insufficient skill by executing the job with the trainer and the trainee; and
comparing execution results of the job related to the insufficient skill and/or the number of personnel having the insufficient skill before and after the OJT is executed.
